(19) United States
(12) Patent Application Publication
(10) Pub. No.: US 2024/0332878 A1
(43) Pub. Date: Oct. 3, 2024

(54) Zeus-X Go 6-in-1 Universal Cable

(71) Applicant: Jia Jun Teh, Alexandria (AU)

(72) Inventor: Jia Jun Teh, Alexandria (AU)

(21) Appl. No.: 18/129,578

(22) Filed: Mar. 31, 2023

(51) Int. Cl. H01R 31/06; H02J 7/00

(52) U.S. Cl. CPC H01R 31/06; H02J 7/0042

(57) ABSTRACT

An exemplary approach toward a novel structure of a 6-in-1 charging cable that USB-C, Lightning, and Micro-USB connectors, providing ergonomic design, ease of use, and portability. The assembly allows charging various types of devices swiftly, wherein the Lightning and Micro-USB adapters with a 360-degree rotatable axis, enabling users to switch between all three connectors quickly.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND

### Field of the Invention

This invention relates to a USB (Universal Serial Bus) cable for connecting an external apparatus such as a mobile phone with a USB port of a PC (Personal Computer). More particularly the invention relates to a USB cable that can charge a battery of an external apparatus with unique adapter mechanisms, combining USB-C, Lightning and Micro-USB connectors in an ergonomic way.

### Description of the Related Art

Rechargeable batteries come in many types. Different batteries using different chemical materials require different methods of recharging. Current battery chargers are designed to be used for only one type of battery. For example, a lithium-ion battery requires a different battery charger than a nickel-cadmium battery. Each battery charger is configured only for one purpose, such as to maintain a constant voltage, a constant current, or a predetermined charging algorithm that may vary the voltage or current. More sophisticated battery chargers may use a charging algorithm to charge a battery quickly at first, then slow down the rate of charge as the battery nears full charge. By looking at prior art, various advancements have been seen providing charging cables and devices facilitating the above-mentioned requirements.

U.S. Pat. No. 4,006,396, issued in 1977, shows a universal charger for multiple types of batteries, with circuits for different charging rates. U.S. Pat. No. 5,828,966, issued in 1998, claims a reconfigurable cradle with interchangeable supports to charge different types of mobile phones which may have two or three connectors, and which may have the connectors at the top, bottom or sides. Duracell's 1997 U.S. Pat. No. 5,828,966 describes a universal charger with multiple male tabs for engaging a different number of female slots on different batteries. Palm, Inc.'s 2003 U.S. Pat. No. 6,614,206 describes a charger with multiple USB connections for providing charge to multiple devices.

U.S. Pat. No. 6,894,457 is directed to a charger with multiple cords for charging multiple portable devices. U.S. Pat. No. 5,157,319 shows an induction charger with a magnetic core surrounding the induction coil.

Gomadic's new Universal USB Travel Charger Adapter with Power Surge Protection has a plug which fits any standard AC wall outlet, and a USB port for providing power to a PDA. The USB end of a Power Sync cable is plugged into the integrated USB socket and the adapter is plugged into a standard AC wall outlet.

U.S. Pat. No. 6,211,649B1 is directed to a USB cable according to the present invention has a USB connector connected with a USB port of a PC (Personal Computer), a phone connector connected with a connector of an external connector such as a mobile phone, a control unit, which is situated between the USB connector and the phone connector, for charging a battery of the mobile phone by using power supplied from the USB port of the PC and for transmitting and receiving data with the PC and the mobile phone, and a cable for connecting the USB connector and the phone connector with the control unit respectively.

A Universal USB Charger Kit for Cell Phones from CellPhoneShop.net plugs into a cigarette lighter of a car, and provides a USB connector for providing power. It also provides Motorola, Nextel, Nokia, Samsung, Sony Ericsson cell phone jack connectors. It allows charging a phone through any USB-powered port, with a 5-volt output.

Different devices to be charged use different charging profiles. The charging profile indicates the rate at which charges apply to the device in the form of current per unit of time, as well as the voltage at which the charge is applied. Some devices, such as cordless phones, portable CD players and similar consumer goods, use a slow charger, while other devices, such as cell phones, laptops, and camcorders, use a quick charger. For many devices, it is important to detect when the device is fully charged, so that the battery is not overcharged, thereby causing damage to the battery. Furthermore, each device can be different from other devices in terms of its receiving ports. Thus, one single universal cable providing charging for all types of smart devices is not seen in the prior art.

In short, there are multiple inventions that have been proposed in prior art. However, these solutions are limited and restricted to their conventional architecture and system. The proposed system provides a 6-in-1 universal charging cable with unique adapter mechanisms, combining USB-C, Lightning, and Micro-USB connectors in an ergonomic way.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to an innovative 6-in-1 universal charging cable with unique adapter mechanisms, combining USB-C, Lightning and Micro-USB connectors in an ergonomic way.

It is a further objective of the invention to provide a 6-in-1 universal cable that combines all mainstream connectors on the market into a single cable, enabling users to charge all their devices with ease.

It is moreover the objective of the invention to provide a USB-C to USB-C cable with support for up to 100 W Power Delivery and 5 Gbps data transfer (USB 3.0 standard).

It is also the objective of the invention to provide a universal charging cable wherein one side of the USB-C is paired with a USB-A adapter for older devices, while the other end of the USB-C cable features a Lightning and Micro-USB adapter.

It is a further objective of the invention to provide Lightning and Micro-USB adapters with a 360-degree rotatable axis, enabling users to switch between all three connectors quickly.

It is moreover the objective of the invention to provide a cable that is designed to be a keychain accessory, with magnets between the USB-C connectors allowing it to remain closed on the user's keychain.

It is also the objective of the invention to add a swivel feature to allow the user to rotate it to the side, also up and down to increase versatility.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 discloses the vertical view of the complete assembly as per preferred embodiments of the invention.

FIG. 2 discloses the horizontal view of the proposed assembly as per preferred embodiments of the invention.

FIG. 3 discloses multiple configurations of the proposed assembly as per preferred embodiments of the invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. The current invention in its preferred embodiment discloses an advancement in charging cables. The assembly shows a universal 6-in-1 charging cable design that has unique adapter mechanisms, combining USB-C, Lightning, and Micro-USB connectors in an ergonomic way.

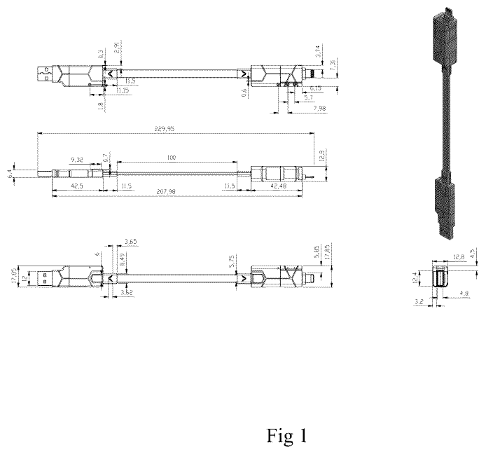

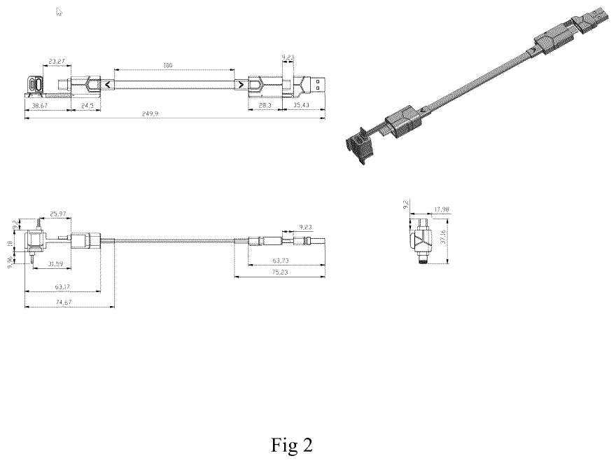

As shown in FIG. 1 and FIG. 2, the universal charging cable is connected by an adaptor to AC power. The universal cable allows connecting to various electronic devices, such as a notebook computer, cell phone, iPod, PDA, mouse, camera, etc. A single universal cable with multiple ports can be used to charge variety of devices.

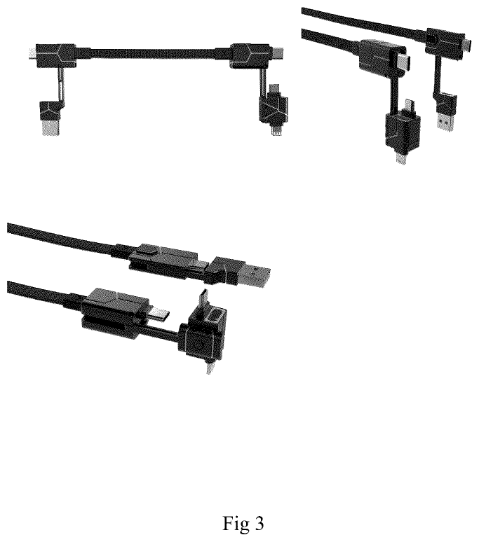

FIG. 3 is showing the aspect of the present invention, wherein the device includes a main USB-C to USB-C cable with support for up to 100 W Power Delivery and 5 Gbps data transfer (USB 3.0 standard). One side of the USB-C is paired with a USB-A adapter for older devices, while the other end of the USB-C cable features a Lightning and Micro-USB adapter. The unique mechanism of this invention holds the Lightning and Micro-USB adapter with a 360-degree rotatable axis, enabling users to switch between all three connectors quickly. This cable is designed to be a keychain accessory, with magnets between the USB-C connectors allowing it to remain closed on the user's keychain.

Another aspect of the present invention is to provide a method for charging multiple devices conveniently and providing a portable universal charging cable assembly without sacrificing functionality. Unlike, the plastic hook used in traditional universal cables which makes them bulky and make them less portable, the proposed 6-in-1 universal cable's 360-degree rotatable axis mechanism solves this problem by enabling the creation of a more compact cable while still retaining all necessary adapters.

Another aspect of the present invention is to provide a method for charging multiple devices conveniently and providing a swivel feature to allow the use to rotate it to the side, also up and down to fulfill the need conveniently with a single hand. It doesn't require the user to change the wires, as seen traditionally. A single 6-in-1 assembly reduces the hassle of maintaining multiple wires and also provides ease of use to the users.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method for configuring a 6-in-1 Universal Cable for charging a plurality of devices, comprising:
a main cable body;
a 5 Gbps data transfer (USB 3.0 standard);
a first connector side of the USB-C paired with a USB-A adapter for older devices and,
a second connector side of the USB-C cable features a lightning and micro-USB adapter.

2. The universal charging cable of claim 1, wherein said charging means comprises voltage control means for charging the battery of the external apparatus by using the power supplied from the USB port with a voltage controlled to be a predetermined value;

3. The universal charging cable of claim 1, wherein the lightning and Micro-USB adapter are provided with a 360-degree rotatable axis, enabling users to switch between all three connectors quickly;

4. The universal charging cable of claim 1, wherein the cable is designed to be a keychain accessory, with magnets between the USB-C connectors allowing it to remain closed on the user's keychain.

5. The universal charging cable of claim 1, wherein the cable enables users to charge all modern USB devices, including smartphones and USB-C laptops.

6. The universal charging cable of claim 1, wherein the cable provides portability and ease of use.

7. The universal charging cable of claim 1, wherein a swivel mechanism to change the ports is provided.
